(19) United States
(12) Patent Application Publication
(10) Pub. No.: US 2023/0348763 A1
(43) Pub. Date: Nov. 2, 2023

(54) UV-CURABLE SEMI-STRUCTURAL ADHESIVE, AND UV-CURABLE SEMI-STRUCTURAL ADHESIVE TAPE

(71) Applicant: 3M INNOVATIVE PROPERTIES COMPANY, St. Paul, MN (US)

(72) Inventors: Yunshu Zhang, Shanghai (CN); Jianda Zhang, Shanghai (CN); Pu Ren, Nanchang (CN)

(21) Appl. No.: 18/044,409

(22) PCT Filed: Aug. 11, 2021
(86) PCT No.: PCT/IB2021/057422

§ 371 Date: Mar. 8, 2023

(30) Foreign Application Priority Data
Sep. 15, 2020 (CN) 202010970438.8

(51) Int. Cl. C09J 133/06; C09J 7/10; C09J 7/38

(52) U.S. Cl. CPC C09J 133/066; C09J 7/10; C09J 7/385; C09J 2203/33; C09J 2301/416; C09J 2433/00; C09J 2463/00

(57) ABSTRACT

The present invention provides a UV-curable semi-structural adhesive, and a UV-curable semi-structural adhesive tape. The UV-curable semi-structural adhesive comprises: 30-80 parts by weight of a polymer base material comprising a product prepared by polymerization of an (meth)acrylate composition; 20-70 parts by weight of an epoxy resin; and a photoacid generator, wherein the (meth)acrylate composition comprises: 40-65 parts by weight of a first (meth)acrylate monomer containing a secondary hydroxyl group; 35-60 parts by weight of a second (meth)acrylate monomer; and a free-radical polymerization photoinitiator. The (meth)acrylate composition does not gel when used in the package-sealed UV polymerization process for producing semi-structural adhesives, and have good compatiility with epoxy composition, enabling the production of semi-structural adhesives through a solvent-free process. In addition, the UV-curable semi-structural adhesive is in a paste state and forms a thick adhesive film on the substrate through one-time coating, simplifying the operation and allowing the adhesive layer formed after UV curing to have high adhesion strength.

### TECHNICAL FIELD

The present invention relates to the technical field of structural adhesives and semi-structural adhesives. In particular, the present invention provides a (meth)acrylate composition, a UV-curable semi-structural adhesive, and a UV-curable semi-structural adhesive tape.

### BACKGROUND

In recent years, electric vehicles have been developed and popularized rapidly for the purpose of environmental protection and energy conservation. In the production process of the power battery of an electric vehicle, square cells are typically assembled together with a structural adhesive. In order to simplify the assembly process, improve the operational efficiency, and balance the performance requirements in aspects such as adhesion strength and shock resistance, the semi-structural adhesive is generally considered to be an ideal choice. In addition, considering that neither heating nor humidification is allowed during the assembly process, the use of heat-curing semi-structural adhesives and moisture-curing semi-structural adhesives are avoided. Currently, people are gradually seeking to employ UV-curable semi-structural adhesives with ideal performance to assemble power batteries for electric vehicles.

Therefore, it is of great significance to develop a UV-curable semi-structural adhesive with convenient adhesion and good adhesion strength.

### SUMMARY

Starting from the technical problems set forth above, one object of the present invention to provide a (meth)acrylate composition that does not gel when used in the package-sealed UV polymerization process for producing semi-structural adhesives, and enhance the compatibility of (meth)acrylate composition and epoxy, thereby enabling the production of semi-structural adhesives through a solvent-free process. Another object of the present invention is to provide a UV-curable semi-structural adhesive which is in a paste state and can form a thick (thickness greater than or equal to 100 µm) adhesive film on a substrate through one-time coating, thereby simplifying the operation and allowing the adhesive layer formed after UV curing to have high adhesion strength.

Particularly, according to one aspect of the present invention, a UV-curable semi-structural adhesive is provided, the UV-curable semi-structural adhesive comprising, based on a total weight of the UV-curable semi-structural adhesive as 100 wt%:
30-80 parts by weight of a polymer base material comprising a product prepared by polymerization of a (meth)acrylate composition;
20-70 parts by weight of an epoxy resin; and
an effective amount of a photoacid generator,
wherein the (meth)acrylate composition comprising, based on a total weigh of the (meth)acrylate composition as 100 wt%:
   40-65 parts by weight of a first (meth)acrylate monomer containing a secondary hydroxyl group;
   35-60 parts by weight of a second (meth)acrylate monomer; and
   an effective amount of a free-radical polymerization photoinitiator.

According to another aspect of the present invention, a UV-curable semi-structural adhesive tape is provided, the UV-curable semi-structural adhesive tape comprising:
an adhesive layer formed by the above-mentioned UV-curable semi-structural adhesive; and
a release layer attached to the adhesive layer.

Compared with the prior art in the art, the present invention has the following advantages: the (meth)acrylate composition does not gel when used in the package-sealed UV polymerization process for producing semi-structural adhesives, thereby enabling the production of semi-structural adhesives through a solvent-free process; and the semi-structural adhesive is in a paste state and can form a thick (thickness greater than or equal to 100 µm) adhesive film on a substrate through one-time coating, thereby simplifying the operation and allowing the adhesive layer formed after UV curing to have high adhesion strength.

### DETAILED DESCRIPTION OF THE PREFERRED EMBODIMENTS

It is to be understood that those of skill in the art can envisage other various embodiments according to teachings in this specification, and can make modifications thereto without departing from the scope or spirit of the present disclosure. Therefore, the following particular embodiments have no limiting meaning.

All figures for denoting characteristic dimensions, quantities and physicochemical properties used in this specification and claims are to be understood as modified by a term “about” in all situations, unless indicated otherwise. Therefore, unless stated conversely, parameters in numerical values listed in the above specification and the claims are all approximate values, and those of skill in the art are capable of seeking to obtain desired properties by taking advantage of contents of the teachings disclosed herein, and changing these approximate values appropriately. The use of a numerical range represented by end points includes all figures within the range and any range within the range, for example, 1 to 5 includes 1, 1.1, 1.3, 1.5, 2, 2.75, 3, 3.80, 4, 5, and the like.

In the present invention, unless otherwise specified, “semi-structural adhesive” refers to those cured adhesives having an overlap shear strength of at least about 0.75 MPa, more preferably at least about 1.0 MPa, and most preferably at least about 1.5 MPa. On the other hand, those cured adhesives with particularly high overlap shear strength are referred to as structural adhesives. Structural adhesives refer to those cured adhesives having an overlap shear strength of at least about 3.5 MPa, more preferably at least about 5 MPa, and most preferably at least about 7 MPa.

At present, power batteries of electric vehicles can be assembled by using a solvent-typed UV-curable semi-structural adhesive. However, solvent-typed UV-curable semi-structural adhesives are generally costly due to the use of organic solvents. In addition, when it is desired to form a thick (thickness greater than or equal to 100 µm) adhesive layer between the cells in the power battery through the solvent-typed UV-curable semi-structural adhesive, a multiple coating + drying process is required, and the process is cumbersome. In addition, a solvent-free UV-curable semi-structural adhesive can be prepared by using a package-sealed UV polymerization process (see, for example, US 6,294,249 B1). The steps of the package-sealed UV polymerization process usually include polymerizing the polymerizable composition in a sealed package by UV-radiation or heating to trigger polymerization, and then hot-melt extrusion of the UV-radiated or heated sealed package, to obtain a solvent-free adhesive. Advantages of the package-sealed UV polymerization process include that a polymer adhesive with high molecular weight can be obtained in a manner of solvent-free polymerization. However, the package-sealed UV polymerization process has very strict requirements on the specific composition of the polymerizable composition. For example, tetrahydrofurfuryl acrylate (THFA) and glycidyl methacrylate (GMA) known to be used in the package-sealed UV polymerization process is susceptible to gelation in the package-sealed UV polymerization process, disabling the preparation of a UV-curable semi-structural adhesive with desired performance.

The inventors of the present invention have discovered through in-depth systematic research that, when an (meth)acrylate composition with specific components and contents is used, no gelation will occur in the package-sealed UV polymerization process for preparing a UV-curable semi-structural adhesive, thereby enabling the production of semi-structural adhesives through a solvent-free process.

According to one aspect of the present invention, an (meth)acrylate composition is provided, the (meth)acrylate composition comprising, based on a total weight of the (meth)acrylate composition as 100 wt%:
40-65 parts by weight of a first (meth)acrylate monomer containing a secondary hydroxyl group;
35-60 parts by weight of a second (meth)acrylate monomer; and
an effective amount of a free-radical polymerization photoinitiator.

According to the technical solution of the present invention, a first (meth)acrylate monomer containing a secondary hydroxyl group is used as an essential component in the (meth)acrylate composition. The first (meth)acrylate monomer containing a secondary hydroxyl group is crucial to prevent gelation in the package-sealed UV polymerization process. Preferably, the first (meth)acrylate monomer containing a secondary hydroxyl group is 2-hydroxypropyl acrylate. The inventors of the present invention discover that gelation occurs when an acrylate monomer containing primary hydroxy, with a very similar structure to the first (meth)acrylate monomer containing a secondary hydroxyl group, is employed in the package-sealed UV polymerization process. For example, gelation occurs when an (meth)acrylate monomer containing primary hydroxy, e.g., 2-hydroxyethyl acrylate (2-HEA) or 4-hydroxybutyl acrylate (4-HBA), with a very similar structure to 2-hydroxypropyl acrylate, is employed in the package-sealed UV polymerization process. Without wishing to be bound by theory, it is believed that due to the presence of hydroxy in the first (meth)acrylate monomer containing a secondary hydroxyl group, the UV-curable semi-structural adhesive prepared by said (meth)acrylate composition has a high modulus and can provide high adhesion strength after curing. In the (meth)acrylate composition, the amount of the first (meth)acrylate monomer containing a secondary hydroxyl group is 40-65 parts by weight, and preferably 45-55 parts by weight.

According to certain preferred embodiments of the present invention, the (meth)acrylate composition is substantially free of solvents, and in some embodiments, is free of thixotropic agents.

The UV-curable semi-structural adhesive prepared by employing the (meth)acrylate composition through the package-sealed UV polymerization process does not contain a solventand simplifies the operation process.

According to certain preferred embodiments of the present invention, the (meth)acrylate composition comprises a second (meth)acrylate monomer. The second (meth)acrylate monomer is used to adjust the glass transition temperature of the (meth)acrylate composition to less than 0° C., thereby to realize room-temperature attachment of the (meth)acrylate composition. Preferably, the second (meth)acrylate monomer is a (meth)acrylate monomer having 4 to 22 carbon atoms. More preferably, the second (meth)acrylate monomer is one or more members selected from the group consisting of: methyl (meth)acrylate, ethyl (meth)acrylate, propyl (meth)acrylate, butyl (meth)acrylate, amyl (meth)acrylate, hexyl (meth)acrylate, heptyl (meth)acrylate, octyl (meth) acrylate, 2-ethylhexyl (meth)acrylate, nonyl (meth)acrylate, decyl (meth)acrylate, undecyl (meth)acrylate, dodecyl (meth)acrylate, tridecyl (meth)acrylate, and stearyl (meth)acrylate. Most preferably, the second (meth)acrylate monomer is butyl acrylate. In the (meth)acrylate composition, the amount of the second (meth)acrylate monomer is 35-60 parts by weight, and preferably 45-55 parts by weight.

For the sake of stability of the (meth)acrylate composition, the second (meth)acrylate monomer substantially contains no acid-functional monomer, and the presence of the acid-functional monomer will initiate the polymerization of the epoxy resin before ultraviolet curing. For the same reason, preferably, the second (meth)acrylate monomer does not contain any amine functional monomer. In addition, preferably, the second (meth)acrylate monomer does not contain any (meth)acrylate monomer having a basic portion, as the basic portion is sufficiently basic to inhibit the polymerization of the (meth)acrylate composition.

Optionally, the (meth)acrylate composition may further comprise one or more epoxy resins having an epoxy equivalent of about 100 to about 1500. Optionally, the (meth)acrylate composition includes one or more epoxy resins having an epoxy equivalent of about 150 to about 600. More preferably, the (meth)acrylate composition contains two or more epoxy resins, where at least one epoxy resin has an epoxy equivalent of about 150 to about 250, or has an epoxy equivalent of about 500 to about 600.

The amount of epoxy resin that can be contained in the (meth)acrylate composition according to the present invention varies according to the desired performance of the (meth)acrylate composition. According to certain preferred embodiments of the present invention, the (meth)acrylate composition comprises 20-70 parts by weight, and preferably 40-70 parts by weight of one or more epoxy resins.

According to certain embodiments of the present invention, the (meth)acrylate composition comprises a free-radical polymerization photoinitiator, to initiate the polymerization of 2-hydroxypropyl acrylate and the second (meth)acrylate monomer. There is no specific restriction on the particular type of the free-radical polymerization photoinitiator that can be used in the present invention, as long as it can effectively initiate polymerization of the alkenyl monomer. Preferably, the free-radical polymerization photoinitiator is one or more members selected from the group consisting of: an acetobenzene initiator, an alpha ketone initiator, a benzoin ether initiator, an arylsulfonyl chloride initiator, and an oxime initiator. Preferably, the amount of the free-radical polymerization photoinitiator is 0.01-1 part by weight, and preferably 0.1-0.15 part by weight. Specific examples of free-radical polymerization photoinitiators that can be used in this application include Irgacure 651 produced by BASF Company.

According to some preferred embodiments of the invention, the (meth)acrylate composition preferably comprises an effect amount of a free-radical crosslinking agent in order to avoid gelation and promote adhesion performance. Preferably, the free-radical crosslinking agent is an acryloxybenzophenone free-radical photocrosslinking agent, including a benzylphenol acrylate crosslinking agent, or a benzylethylphenol acrylate crosslinking agent. Preferably, the amount of the free-radical crosslinking agent is 0.01-1 part by weight, and preferably 0.1-0.25 part by weight. Specific examples of free-radical crosslinking agents that can be used in this application include 4-acryloyl-oxy-benzophenone (Product name: ABP) produced by 3 M Company.

According to some preferred embodiments of the present invention, in order to avoid gelation and promote adhesion performance, the (meth)acrylate composition also preferably comprises an effect amount of a chain transfer agent. Preferably, the chain transfer agent is a sulfur-containing chain transfer agent, or a haloalkane chain transfer agent. Preferably, the amount of the chain transfer agent is 0.01-1 part by weight, and preferably 0.1-0.15 part by weight. Specific examples of chain transfer agents that can be used in this application include isooctyl mercaptoacetate (Product name: IOTG) produced by Bruno Bock Company.

According to some preferred embodiments of the present invention, in order to facilitate the subsequent operation of preparing the UV-curable semi-structural adhesive, the (meth)acrylate composition has a viscosity at 25° C. of less than 50,000 centipoise, preferably a viscosity at 25° C. of less than 5000 centipoise, and more preferably a viscosity at 25° C. of less than 50 centipoise. When the (meth)acrylate composition is an unfilled monomer mixture, it is preferred that the (meth)acrylate composition has a viscosity at 25° C. of less than 50 centipoise.

In addition, the melting point of the (meth)acrylate composition is less than or equal to 40° C., preferably less than or equal to 25° C., and more preferably less than or equal to 0° C.

There is no particular limitation on the preparation method of the (meth)acrylate composition, and it can be prepared by simple mixing.

According to another aspect of the present invention, a UV-curable semi-structural adhesive is provided, the UV-curable semi-structural adhesive comprising, based on a total weight of the UV-curable semi-structural adhesive as 100 wt%:
30-80 parts by weight of a polymer base material comprising a product prepared by polymerization of the above-mentioned (meth)acrylate composition;
20-70 parts by weight of an epoxy resin; and
an effective amount of a photoacid generator.

According to certain preferred embodiments of the present invention, the polymer base material is prepared by a package-sealed UV polymerization process. Specifically, the polymer base material is prepared by the following steps of:
sealing the (meth)acrylate composition in a plastic package;
UV-radiating the (meth)acrylate composition in the plastic package encapsulating to trigger polymerization; and
melt-extruding the UV-radiated (meth)acrylate composition with the plastic package to obtain the polymer base material.

Preferably, the intensity of the UV-radiation is in the range of 0.01-20 mW/cm², and the time of the UV-radiation treatment is in the range of 5-15 min.

In the UV-curable semi-structural adhesive, the amount of the polymer base material is in the range of 30-80 parts by weight, and preferably 30-50 parts by weight.

The specific types of epoxy resins that can be used in the present invention are not particularly limited, and can be appropriately selected from various conventional epoxy resins in the field of preparation of structural adhesives. Preferably, the epoxy equivalent of the epoxy resin is in the range of 150-600. More preferably, the epoxy resin is an ester-ring epoxy resin. The ester-ring epoxy resin can be obtained by reaction between polyphenol and epichlorohydrin according to a conventional polymerization method in the art. The polyphenol is one or more members selected from the group consisting of: bisphenol A, bisphenol F, bisphenol S, hexahydrobisphenol A, tetramethyl bisphenol A, diaryl bisphenol A, and tetramethyl bisphenol F. In the UV-curable semi-structural adhesive, the amount of the epoxy resin is in the range of 20-70 parts by weight, and preferably 50-70 parts by weight. Commercially available examples of epoxy resins that can be used in the present invention include EP828 produced by Hexion Company.

The choice of epoxy resin used depends on its intended end use. In the case where greater ductility is required for the adhesion line, an epoxide with a flexible backbone may be required. Materials such as the diglycidyl ether of bisphenol A and the diglycidyl ether of bisphenol F can provide ideal structural adhesion performance that these materials can obtain during curing, and the hydrogenated forms of these epoxy resins can be used for compatibility with substrates having oily surfaces.

Examples of commercially available epoxides that can be used in the present disclosure include diglycidyl ether of bisphenol A (e.g., commodities commercially available from Momentive Specialty Chemicals, Inc. under the trade names EPON 828, EPON 1001, EPON 1004, EPON 2004, EPON 1510 and EPON 1310, and commodities commercially available from Dow Chemical Company under the trade names D.E.R. 331, D.E.R. 332, D.E.R. 334 and D.E.N. 439; diglycidyl ether of bisphenol F (e.g., a product available from Huntsman Corporation under the trade name ARALDITE GY 281); organosilicon resins containing diglycidyl epoxy functional groups; flame retardant epoxy resins (e.g., brominated bisphenol epoxy resin available from Dow Chemical Co. under the trade name DER 560); and 1,4-butanediol diglycidyl ether.

According to some embodiments of the invention, the UV-curable semi-structural adhesive also comprises one or more photoacid generators. The photoacid generator is one or more members selected from the group consisting of: diaryliodonium salts, triarylsulfonium salts, alkylsulfonium salts, iron aromatic hydrocarbon salts, sulfonyloxyketone, triaryl siloxane, hexafluoroantimonate, and triarylsulfonium hexafluorophosphate. There is no particular limitation on the amount of the photoacid generator, as long as it can effectively trigger polymerization of the polymer base material and the epoxy resin when the UV-curable semi-structural adhesive is cured by UV light. Preferably, the amount of the photoacid generator is 0.1-5 parts by weight. Particular commercially available examples of photoacid generators that can be used in the present invention include Chivacure 1176 produced by Chitec Company.

According to certain preferred embodiments of the present invention, optionally, the polymer base material further comprises a viscosity modifier, to adjust the viscosity of the UV-curable semi-structural adhesive to a suitable range. Preferably, the viscosity modifier is an ethylene-vinyl acrylate copolymer or an ethylene-acrylic acid copolymer. Preferably, in the step of preparing the polymer base material described above, the plastic package employed contains the ethylene-vinyl acrylate copolymer or the ethylene-acrylic acid copolymer. More preferably, the plastic package employed is made of the ethylene-vinyl acrylate copolymer or the ethylene-acrylic acid copolymer. The above-mentioned copolymer can be melted and mixed together with the polymerization product obtained by UV-radiation of the (meth)acrylate composition, and the copolymer will not significantly affect adhesion properties of the UV-curable semi-structural adhesive obtained in the subsequent steps.

The preparation method of the UV-curable semi-structural adhesive is not particularly limited, and it can be prepared by simply mixing the polymer base, the epoxy resin and the photoacid generator.

Specifically, the UV-curable semi-structural adhesive can be prepared through the following steps. The first (meth)acrylate monomer containing a secondary hydroxyl group, the second (meth)acrylate monomer, the chain transfer agent, the crosslinking agent, and the free-radical polymerization photoinitiator are intensively mixed in a specific ratio to obtain an (meth)acrylate composition. On the plastic packaging machine, two heat-sealable ethylene-vinyl acrylate copolymer films (VA24) (thickness 0.0635 mm, containing 6 wt% vinyl acrylate) commercially available from Consolidated Thermoplastics Co., USA are cut separately and heat sealed along edges thereof to form a rectangular package. The (meth)acrylate composition prepared above is filled into the rectangular package. Then, the filling port of the filled rectangular package is heat-sealed, to form a sealed package of a specific size, which contains the (meth)acrylate composition. The sealed package is placed in a water bath at a temperature between about 21° C. and 32° C., and then the sealed package encapsulating the (meth)acrylate composition is subjected to UV-radiation to trigger polymerization. The sealed package obtained above containing the (meth)acrylate composition polymerized by UV-radiation is fed into a single-screw extruder, heated and melted. Specific amounts of a liquid epoxy resin and a photoacid generator are fed into the middle of the single-screw extruder, and the mixture is extruded in a specific thickness onto a release film, thereby to obtain an adhesive tape, i.e., an adhesive tape comprising a UV-curable semi-structural adhesive layer and a release layer.

In the above steps, the ethylene-vinyl acrylate copolymer as a viscosity modifier is made into an encapsulation package for the package-sealed UV polymerization process, and in the later stage of preparing the UV-curable semi-structural adhesive, the encapsulation package and the (meth)acrylate composition polymerized by UV-radiation contained in the encapsulation package are co-melted and extruded in a single-screw extruder. However, optionally, the encapsulation package may be removed after the step of subjecting the sealed package encapsulating the (meth)acrylate composition to UV-radiation to trigger polymerization, and thereby only the (meth)acrylate composition polymerized by UV-radiation in the encapsulation package is separately mixed and extruded with the epoxy resin and the photoacid generator in the single-screw extruder, to obtain a UV-curable semi-curable adhesive without the ethylene-vinyl acrylate copolymer ingredient as a viscosity modifier.

According to yet another aspect of the present invention, a UV-curable semi-structural adhesive tape is provided, the UV-curable semi-structural adhesive tape comprising:
an adhesive layer formed by the above-mentioned UV-curable semi-structural adhesive; and
a release layer attached to the adhesive layer.

The specific preparation method of the above-mentioned UV-curable semi-structural adhesive tape is not particularly limited. For example, the above-mentioned UV-curable semi-structural adhesive may be melt-extruded onto the release layer to form an adhesive layer. The specific material and thickness of the release layer that can be used in the present invention are not particularly limited. For example, the release layer may be selected from various release papers, polymer release films and the like commonly used in the field of adhesive tape preparation.

Various exemplary embodiments of the present invention are further described by a list of embodiments below, which should not be construed as unduly limiting the present invention:

Particular embodiment 1 is a UV-curable semi-structural adhesive, the UV-curable semi-structural adhesive comprising, based on a total weight of the UV-curable semi-structural adhesive as 100 wt%:
30-80 parts by weight of a polymer base material comprising a product prepared by polymerization of an (meth)acrylate composition;
20-70 parts by weight of an epoxy resin; and
an effective amount of a photoacid generator.
wherein the (meth)acrylate composition comprising, based on a total weight of the (meth)acrylate composition as 100 wt%:
   40-65 parts by weight of a first (meth)acrylate monomer containing a secondary hydroxyl group;
   35-60 parts by weight of a second (meth)acrylate monomer; and
   an effective amount of a free-radical polymerization photoinitiator.

Particular embodiment 2 is the UV-curable semi-structural adhesive according to Particular embodiment 1, wherein the first (meth)acrylate monomercomprising a secondary hydroxyl group is 2-hydroxypropyl acrylate.

Particular embodiment 3 is the UV-curable semi-structural adhesive according to Particular embodiment 1, wherein the (meth)acrylate composition contains no solvent.

Particular embodiment 4 is the UV-curable semi-structural adhesive according to Particular embodiment 1, wherein the second (meth)acrylate monomer is a (meth)acrylate monomer having 4-22 carbon atoms.

Particular embodiment 5 is the UV-curable semi-structural adhesive according to Particular embodiment 1, wherein the second (meth)acrylate monomer is one or more members selected from the group consisting of: methyl (meth)acrylate, ethyl (meth)acrylate, propyl (meth)acrylate, butyl (meth)acrylate, amyl (meth)acrylate, hexyl (meth)acrylate, heptyl (meth)acrylate, octyl (meth) acrylate, 2-ethylhexyl (meth)acrylate, nonyl (meth)acrylate, decyl (meth)acrylate, undecyl (meth)acrylate, dodecyl (meth)acrylate, tridecyl (meth)acrylate, and stearyl (meth)acrylate.

Particular embodiment 6 is the UV-curable semi-structural adhesive according to Particular embodiment 1, wherein the second (meth)acrylate monomer comprises butyl acrylate.

Particular embodiment 7 is the UV-curable semi-structural adhesive according to Particular embodiment 1, wherein the free-radical polymerization photoinitiator is one or more members selected from the group consisting of: an acetobenzene initiator, an alpha ketone initiator, a benzoin ether initiator, an arylsulfonyl chloride initiator, and an oxime initiator.

Particular embodiment 8 is the UV-curable semi-structural adhesive according to Particular embodiment 1, wherein the (meth)acrylate composition further comprises an effective amount of a free-radical crosslinking agent, the free-radical crosslinking agent comprising an acryloxybenzophenone free-radical photocrosslinking agent, including a benzylphenol acrylate crosslinking agent, or a benzylethylphenol acrylate crosslinking agent.

Particular embodiment 9 is the UV-curable semi-structural adhesive according to Particular embodiment 1, wherein the (meth)acrylate composition further comprises an effective amount of a chain transfer agent, the chain transfer agent comprising a sulfur-containing chain transfer agent, or a haloalkane chain transfer agent.

Particular embodiment 10 is the UV-curable semi-structural adhesive according to Particular embodiment 1, wherein the (meth)acrylate composition has a viscosity at 25° C. of less than 50,000 centipoise.

Particular embodiment 11 is the UV-curable semi-structural adhesive according to Particular embodiment 1, wherein the (meth)acrylate composition has a melting temperature of less than or equal to 40° C.

Particular embodiment 12 is the UV-curable semi-structural adhesive according to any of Particular embodiments 1 to 11, wherein the polymer base material is prepared by the steps of:
sealing the (meth)acrylate composition in a plastic package;
UV-radiating the (meth)acrylate composition in the plastic package to trigger polymerization; and
melt-extruding the UV-radiated (meth)acrylate composition with the plastic package to obtain the polymer base material.

Particular embodiment 13 is the UV-curable semi-structural adhesive according to Particular embodiment 12, wherein the intensity of the UV-radiation ranges from 0.01 to 20 mW/cm².

Particular embodiment 14 is the UV-curable semi-structural adhesive according to any of Particular embodiments 1 to 11, wherein the epoxy equivalent of the epoxy resin ranges from 150 to 600.

Particular embodiment 15 is the UV-curable semi-structural adhesive according to any of Particular embodiments 1 to 11, wherein the epoxy resin is an ester-ring epoxy resin.

Particular embodiment 16 is the UV-curable semi-structural adhesive according to Particular embodiment 15, wherein the ester-ring epoxy resin is obtained by reaction between polyphenol and epichlorohydrin.

Particular embodiment 17 is the UV-curable semi-structural adhesive according to Particular embodiment 16, wherein the polyphenol is one or more members selected from the group consisting of: bisphenol A, bisphenol F, bisphenol S, hexahydrobisphenol A, tetramethyl bisphenol A, diaryl bisphenol A, and tetramethyl bisphenol F.

Particular embodiment 18 is the UV-curable semi-structural adhesive according to any of Particular embodiments 1 to 11, wherein the photoacid generator is one or more members selected from the group consisting of diaryliodonium salts, triarylsulfonium salts, alkylsulfonium salts, iron aromatic hydrocarbon salts, sulfonyloxyketone, triaryl siloxane, hexafluoroantimonate, and triarylsulfonium hexafluorophosphate.

Particular embodiment 19 is the UV-curable semi-structural adhesive according to Particular embodiment 12, wherein the polymer base material further comprises a viscosity modifier.

Particular embodiment 20 is the UV-curable semi-structural adhesive according to Particular embodiment 19, wherein the viscosity modifier is an ethylene-vinyl acrylate copolymer or an ethylene-acrylic acid copolymer.

Particular embodiment 21 is the UV-curable semi-structural adhesive according to Particular embodiment 20, wherein the plastic package comprises the ethylene-vinyl acrylate copolymer or the ethylene-acrylic acid copolymer.

Particular embodiment 22 is a UV-curable semi-structural adhesive tape, the UV-curable semi-structural adhesive tape comprising:
an adhesive layer formed by the UV-curable semi-structural adhesive stated in any of Particular embodiments 1 to 21; and
a release layer attached to the adhesive layer.

Particular embodiment 23 is an (meth)acrylate composition, the (meth)acrylate composition comprising:
40-65 parts by weight of a first (meth)acrylate monomer containing a secondary hydroxyl group;
35-60 parts by weight of a second (meth)acrylate monomer; and
an effective amount of a free-radical polymerization photoinitiator.

Particular embodiment 24 is the (meth)acrylate composition according to Particular embodiment 23, wherein the first (meth)acrylate monomer comprising a secondary hydroxyl group is 2-hydroxypropyl acrylate.

Particular embodiment 25 is the (meth)acrylate composition according to Particular embodiment 23, wherein the (meth)acrylate composition contains no solvent.

Particular embodiment 26 is the (meth)acrylate composition according to Particular embodiment 23, wherein the second (meth)acrylate monomer is a (meth)acrylate monomer having 4-22 carbon atoms.

Particular embodiment 27 is the (meth)acrylate composition according to Particular embodiment 23, wherein the second (meth)acrylate monomer is one or more members selected from the group consisting of: methyl (meth)acrylate, ethyl (meth)acrylate, propyl (meth)acrylate, butyl (meth)acrylate, amyl (meth)acrylate, hexyl (meth)acrylate, heptyl (meth)acrylate, octyl (meth) acrylate, 2-ethylhexyl (meth)acrylate, nonyl (meth)acrylate, decyl (meth)acrylate, undecyl (meth)acrylate, dodecyl (meth)acrylate, tridecyl (meth)acrylate, and stearyl (meth)acrylate.

Particular embodiment 28 is the (meth)acrylate composition according to Particular embodiment 23, wherein the (second) acrylate monomer comprises butyl acrylate.

Particular embodiment 29 is the (meth)acrylate composition according to Particular embodiment 23, wherein the free-radical polymerization photoinitiator is one or more members selected from the group consisting of: an acetobenzene initiator, an alpha ketone initiator, a benzoin ether initiator, an arylsulfonyl chloride initiator, and an oxime initiator.

Particular embodiment 30 is the (meth)acrylate composition according to Particular embodiment 23, wherein the (meth)acrylate composition further comprises an effective amount of a free-radical crosslinking agent, the free-radical crosslinking agent comprising an acryloxybenzophenone free-radical photocrosslinking agent, including a benzylphenol acrylate crosslinking agent, or a benzylethylphenol acrylate crosslinking agent.

Particular embodiment 31 is the (meth)acrylate composition according to Particular embodiment 23, wherein the (meth)acrylate composition further comprises an effective amount of a chain transfer agent, the chain transfer agent comprising a sulfur-containing chain transfer agent, or a haloalkane chain transfer agent.

Particular embodiment 32 is the (meth)acrylate composition according to Particular embodiment 23, wherein the (meth)acrylate composition has a viscosity at 25° C. of less than 50,000 centipoise.

Particular embodiment 33 is the (meth)acrylate composition according to Particular embodiment 23, wherein the (meth)acrylate composition has a melting temperature of less than or equal to 40° C.

The present invention will be described below in more details in combination with examples. It needs to be pointed out that these descriptions and examples are all intended to make the invention easy to understand, rather than to limit the invention. The protection scope of the present invention is subject to the appended claims.

### EXAMPLES

In the present invention, unless otherwise pointed out, the reagents employed are all commercially available products, which are directly used without further purification.

TABLE 1

List of raw materials

| | | |
|---|---|---|
| Component | Product name | Supplier |
| Butyl acrylate, monomer | BA | HuaYi Company |
| 2-hydroxypropyl acrylate, monomer | 2-HPA | BASF (Germany) |
| 2-hydroxyethyl acrylate, monomer | 2-HEA | BASF Company (Germany) |
| 4-hydroxybutyl acrylate, monomer | 4-HBA | BASF Company (Germany) |
| Isooctyl mercaptoacetate, chain transfer agent | IOTG | Zhongxin Company (China) |
| Benzylphenol acrylate, free-radical photocrosslinking agent (4-acryloyl-oxy-benzophenone) | ABP | 3M Company (US) |
| Liquid epoxy resin | EP828 | Hexion Company (China) |
| Solid epoxy resin | EP1001 | Hexion Company (China) |
| Free-radical polymerization photoinitiator | Irgacure 651 | BASF Company (China) |
| Photoacid generator | Chivacure 1176 | Chitec Company (China) |

### Testing Method

### Viscosity of (Meth)Acrylate Composition

Viscosity is measured based on GB/T 22235-2008 “Method for Measuring Liquid Viscosity,” with a Brookfiled Viscometer rotational viscometer at a constant temperature of 25° C. and a constant shear rate of 200 rps, with a 61# test rotor. The lower limit of this test instrument is 10 cps.

### Melting Point of (Meth)Acrylate Composition

For samples that are liquid at 25° C., the default melting point thereof is lower than 40° C. For samples that are solid at 25° C., the visual method in GB/T 617-2006 “General Methods for the Determination of Melting Point Range of Chemical Reagents” is employed for determination. That is, the sample is added to a melting point tube, and the sample in the melting point tube is gradually increased from a temperature lower than its initial melting temperature to a temperature higher than its final melting temperature by heating, and temperatures at which the sample initially melts and finally melts are visually observed to determine the melting point range of the sample.

### Overlap Shear Strength

Two aluminum sheets (4 inches x 1 inch x 0.0625 inches) are gently ground with a wire brush and then wiped with isopropanol. Then, the side of the adhesive tape obtained by each of the following examples and comparative examples exposed to the UV-curable semi-structural adhesive is applied on one surface of an aluminum sheet, and then the release film is peeled off. Then, the exposed UV-curable semi-structural adhesive is irradiated with an UV-radiation intensity of 1000 W/cm² for 3 s. After the UV-irradiation, the second aluminum sheet is immediately applied to the UV-curable semi-structural adhesive with an overlap area of 1 square inch (6.45 cm²), to obtain a sample for the test of overlap shear strength. Then, the sample is divided into Sample A and Sample B. Immediately after the UV-irradiation, Sample A is measured for the overlap shear strength at 25° C. with a tensile tester produced by Instron Company, to obtain the initial overlap shear strength in MPa. After the UV-irradiation treatment, and on day 3 of the storage at room temperature, Sample B is measured for the overlap shear strength at 25° C. with a tensile tester produced by Instron Company, to obtain the final overlap shear strength in MPa. When the final overlap shear strength is greater than or equal to 2 MPa, it is believed that the UV-curable semi-structural adhesive can meet the basic requirements for the final adhesion strength performance.

### Preparation Example 1 (PE1)

The polymer base 1 was prepared by the following steps. 50 parts by weight of butyl acrylate, 50 parts by weight of 2-hydroxypropyl acrylate, 0.15 part by weight of a chain transfer agent isooctyl mercaptoacetate (IOTG), 0.25 part by weight of a crosslinking agent 4-acryloyl-oxy-benzophenone (ABP)) and 0.15 part by weight of a free-radical polymerization photoinitiator (Irgacure 651) were intensively mixed to obtain an (meth)acrylate composition 1. Subsequently, the (meth)acrylate composition 1 was measured for the viscosity and the melting point, according to the method for measuring the viscosity and the melting point of the (meth)acrylate composition described in detail above, and the results obtained are shown in Table 2 below. On the plastic packaging machine, two heat-sealable ethylene-vinyl acrylate copolymer films (VA24) (thickness 0.0635 mm, comprising 6 wt% vinyl acrylate) commercially available from Consolidated Thermoplastics Co., USA were cut separately and heat-sealed along the edges thereof to form a rectangular package. Subsequently, the (meth)acrylate composition 1 prepared above was filled into the rectangular package. Then, the filling port of the filled rectangular package was heat-sealed to form a sealed package with a size of 13.6 cm x 4.6 cm, which contained 25±1 g of the (meth)acrylate composition 1.

The sealed package was placed in a water bath at a temperature between about 21° C. and 32° C., and the sealed package encapsulating the (meth)acrylate composition 1 was subjected to UV-radiation (radiation intensity: about 2 mW/cm²; radiation time: 8.33 min) to trigger polymerization. The UV-radiation was provided by an ultraviolet lamp having an emission wavelength between 300 and 400 nanometers (nm) (about 90%) and a peak at 351 nm. After the treatment by UV-radiation, the state of the product in the sealed package was observed to see if gelation occurred, and the observation results were recorded in Table 2.

### Preparation Examples 2-8 (PE2-PE8) and Comparative Preparation Examples 1-4 (CPE1-CPE4)

(meth)acrylate compositions 2-8 and comparative (meth)acrylate compositions 1-4 were prepared in a similar manner to Preparation example 1, and polymer base materials 2-8 and comparative polymer base materials 1-4 were further prepared in a similar manner to Preparation example 1, except that types and contents of raw materials were changed according to the contents shown in Table 2 below. Where, (meth)acrylate compositions 2-8 and comparative (meth)acrylate compositions 1-4were measured for the viscosity and the melting point, according to the method for measuring the viscosity and the melting point of the (meth)acrylate composition described in detail above, and the results obtained are shown in Table 2 below. After the treatment by UV-radiation, the state of the product in each sealed package was observed to see if gelation occurred, and the observation results were recorded in Table 2.

### Example 1 (E1)

The sealed package obtained above in Preparation Example 1 and containing the (meth)acrylate composition 1 polymerized by UV-radiation was fed into a single-screw extruder provided by Haake Company (barrel temperature set to about 177° C., and die temperature set to about 177° C.), heated and melted, and a liquid epoxy resin EP828 and a photoacid generator Chivacure 1176 were fed into the middle of the single-screw extruder (where, based on 30 parts by weight of the sealed package containing the the (meth)acrylate composition 1 polymerized by UV-radiation, the amount of the liquid epoxy resin EP828 added was 70 parts by weight, and the amount of the photoacid generator Chivacure 1176 added was 1 part by weight). The mixture was extruded in the form of a 75-mm thick paste onto the release paper (from 3M Company), to obtain an adhesive tape 1. The adhesive tape 1 was tested according to the method for measuring overlap shear strength described above and the test results are shown in Table 3.

### Examples 2-15 (E2-E15) and Comparative Examples 1-5 (C1-C5)

Adhesive tapes 2-15 and comparative adhesive tapes 1-5 were prepared in a similar manner to Example 1, except that types and contents of the polymer base material, the epoxy resin and the photoacid generator were changed according to the contents shown in Table 3 below. Each adhesive tape was tested according to the method for measuring overlap shear strength described above and the test results are shown in Table 3.

TABLE 2

Compositions of raw materials in Preparation examples 1-8 (PE1-PE8) and Comparative preparation examples (CPE1-CPE4) and the observation results of the state of the resulting product

| Raw material (parts by weight) | PE1 | PE2 | PE3 | PE4 | PE5 | PE6 | PE7 | PE8 | CPE-1 | CPE-2 | CPE-3 | CPE-4 |
|---|---|---|---|---|---|---|---|---|---|---|---|---|
| Butyl acrylate | 50 | 60 | 35 | 50 | 50 | 50 | 50 | 50 | 70 | 50 | 50 | 30 |
| 2-Hydroxypropyl acrylate | 50 | 40 | 65 | 50 | 50 | 50 | 50 | 50 | 30 | | | 70 |
| 2-Hydroxyethyl acrylate | | | | | | | | | | 50 | | |
| 4-Hydroxybutyl acrylate | | | | | | | | | | | 50 | |
| Chain transfer agent IOTG | 0.15 | 0.15 | 0.15 | 0.15 | 0.1 | 0.05 | 0.025 | | 0.15 | 0.15 | 0.15 | 0.15 |
| Free-radical crosslinking agent ABP | 0.25 | 0.25 | 0.25 | | | | | | 0.25 | 0.25 | 0.25 | 0.25 |
| Photoinitiator (Irgacure 651) | 0.15 | 0.15 | 0.15 | 0.15 | 0.15 | 0.15 | 0.15 | 0.15 | 0.15 | 0.15 | 0.15 | 0.15 |
| State of the product | Transparent viscous substance | Transparent viscous substance | Transparent viscous substance | Transparent viscous substance | Transparent viscous substance | Transparent viscous substance | Transparent viscous substance | Transparent viscous substance | Transparent viscous substance | Gelation | Gelation | Hard block, disabling the subsequent hot-melt extrusion |
| Viscosity of reactants (centipoise) | <10 | <10 | 12 | <10 | <10 | <10 | <10 | <10 | <10 | <10 | <10 | 13 |
| Melting point of reactants (°C) | <25 | <25 | <25 | <25 | <25 | <25 | <25 | <25 | <25 | <25 | <25 | <25 |

TABLE 3

Compositions of raw materials in Examples 1-15 (E1-E15) and Comparative examples 1-5 (C1-C5) and measurement results of overlap shear strength of adhesive tapes obtained

| Raw material (parts by weight) | Polymer base material in Preparation example 1 | Polymer base material in Preparation example 2 | Polymer base material in Preparation example 3 | Polymer base material in Preparation example 4 | Polymer base material in Preparation example 5 | Polymer base material in Preparation example 6 | Polymer base material in Preparation example 6 | Polymer base material in Preparation example 8 | Polymer base material in Comparative preparation example 1 | Epoxy resin EP828 | Epoxy resin EP1001 | Photoacid generator Chivacure 1176 | Overlap shear strength (MPa) | |
|---|---|---|---|---|---|---|---|---|---|---|---|---|---|---|
| | | | | | | | | | | | | | Initial overlap shear strength (25° C., measured immediately after UV treatment) | Final overlap shear strength (25° C., measured after 3-day curing at room temperature) |
| Ex 1 | 30 | | | | | | | | | 70 | | 1 | NA | 8.4 |
| Ex 2 | 50 | | | | | | | | | 50 | | 1 | NA | 5.9 |
| Ex 3 | 60 | | | | | | | | | 40 | | 1 | NA | 4.6 |
| Ex 4 | 80 | | | | | | | | | 20 | | 1 | NA | 2.8 |
| Ex 5 | | 50 | | | | | | | | 50 | | 1 | NA | 4.3 |
| Ex 6 | | | 50 | | | | | | | 50 | | 1 | 0.3 | 5.5 |
| Ex 7 | | | 60 | | | | | | | 40 | | 1 | 0.3 | 5.2 |
| Ex 8 | 50 | | | | | | | | | 50 | | 0.1 | NA | 2.2 |
| Ex 9 | 50 | | | | | | | | | 50 | | 5 | NA | 7.3 |
| Ex 10 | | | | 50 | | | | | | 50 | | 1 | 0.02 | 3.8 |
| Ex 11 | | | | | 50 | | | | | 50 | | 1 | 0.02 | 4.3 |
| Ex 12 | | | | | | 50 | | | | 50 | | 1 | 0.02 | 5.9 |
| Ex 13 | | | | | | | 50 | | | 50 | | 1 | 0.03 | 5.8 |
| Ex 14 | | | | | | | | 50 | | 50 | | 1 | 0.04 | 4.0 |
| Ex 15 | | | | | | | | 50 | | 25 | 25 | 1 | 0.09 | 2.8 |
| Comp ex 1 | 20 | | | | | | | | | 80 | | 1 | The mixture extruded from the single-screw extruder was too viscous to form a film, and it is impossible to measure the overlap shear strength. | |
| Comp ex 2 | 90 | | | | | | | | | 10 | | 1 | NA | 1.7 |
| Comp ex 3 | | | | | | | | | 50 | 50 | | 1 | The mixture system was hazy, indicating quite poor compatibility among the components. | |
| Comp ex 4 | 50 | | | | | | | | | 50 | | | NA | 0.4 |
| Comp ex 5 | 50 | | | | | | | | | 50 | | 8 | NA | 1.2 |

NA: Not tested

From the results of Preparation examples 1-8 shown in Table 2 above, it can be seen that, when an (meth)acrylate composition is prepared within the scope of the present invention and the (meth)acrylate composition is subjected to UV-radiation polymerization treatment, the resulting polymer base material is in a transparent viscous state, without gelation, and does not produce hard blocks that are not conducive to the subsequent operation.

From the results of Comparative preparation examples 2 and 3 shown in Table 2 above, it can be seen that, when a (meth)acrylate monomer containing primary hydroxy (i.e., 2-hydroxyethyl acrylate or 4-hydroxybutyl acrylate) which has a structure very similar to 2-hydroxypropyl acrylate is used in the package-sealed UV polymerization process, gelation will surprisingly occur.

From the results of Comparative preparation example 4 shown in Table 2 above, it can be seen that, when the content of 2-hydroxypropyl acrylate in the (meth)acrylate composition system is too high (70 parts by weight), the resulting polymer base material is a hard block, and it is impossible to perform the subsequent operation of hot-melt extrusion.

From the results of Examples 1-15 shown in Table 3 above, it can be seen that, when the polymer base material is prepared within the scope of the present invention and used in the preparation of UV-curable semi-structural adhesives, the resulting UV-curable semi-structural adhesive has a good UV curing effect, and has good final adhesion performance (final overlap shear strength).

From the results of Comparative Example 1 shown in Table 3 above, it can be seen that, when the amount of the polymer base material is too small (20 parts by weight), the mixture extruded from the single-screw extruder is too viscous to be formed into a film and measured for the overlap shear strength.

From the results of Comparative Example 2 shown in Table 3 above, it can be seen that, when the amount of the polymer base material is too large (90 parts by weight), the cured product of the UV-curable semi-structural adhesive obtained has final adhesion performance that is too low, and cannot meet requirements for battery assembly.

From the results of Comparative Example 3 shown in Table 3 above, it can be seen that, when the polymer base material in Comparative preparation example 1 is employed to prepare the UV-curable semi-structural adhesive, the mixture system of the polymer base material and epoxy resin becomes foggy, indicating poor compatibility among the poly(meth)acrylate and epoxy component when the content of 2-hydroxypropyl acrylate in the (meth)acrylate composition system is too low.

From the results of Comparative Example 4 shown in Table 3 above, it can be seen that, if no photoacid generator is added in the process of preparing the UV-curable semi-structural adhesive, the cured product of the UV-curable semi-structural adhesive obtained has initial adhesion performance that is too low, and cannot meet requirements for battery assembly.

From the results of Comparative Example 5 shown in Table 3 above, it can be seen that, if an excessive amount of the photoacid generator (8 parts by weight) is added in the process of preparing the UV-curable semi-structural adhesive, the UV curing process will proceed too fast, and the surface wettability of the obtained UV-curable semi-structural adhesive is too low, resulting in final adhesion performance that is too low, which cannot meet requirements for battery assembly.

Though the above particular embodiments comprise a great many concrete details for the purpose of illustration through specific examples, it is to be understand by those of ordinary skill in the art that, many variations, modifications, replacements and changes to these details shall all fall within the scope of the present invention as claimed in the claims. Therefore, the disclosure as described in the specific embodiments does not pose any limitation to the present invention as claimed in the claims. The proper scope of the present invention should be defined by the claims and proper legal equivalents thereof. All references referred to are incorporated herein by reference in their entireties.

1. A UV-curable semi-structural adhesive, the UV-curable semi-structural adhesive comprising, based on a total weight of the UV-curable semi-structural adhesive as 100 wt%:
30-80 parts by weight of a polymer base material comprising a product prepared by polymerization of a (meth)acrylate composition;
20-70 parts by weight of an epoxy resin; and
an effective amount of a photoacid generator,
wherein the (meth)acrylate composition comprising, based on a total weight of the (meth)acrylate composition as 100 wt%:
40-65 parts by weight of a first (meth)acrylate monomer containing a secondary hydroxyl group;
35-60 parts by weight of a second (meth)acrylate monomer; and
an effective amount of a free-radical polymerization photoinitiator.

2. The UV-curable semi-structural adhesive according to claim 1, wherein the first (meth)acrylate monomer comprising a secondary hydroxyl group is 2-hydroxypropyl acrylate.

3. The UV-curable semi-structural adhesive according to claim 1, wherein the (meth)acrylate composition contains no solvent.

4. The UV-curable semi-structural adhesive according to claim 1, wherein the second (meth)acrylate monomer is an acrylate monomer having 4-22 carbon atoms.

5. The UV-curable semi-structural adhesive according to claim 1, wherein the second (meth)acrylate monomer is one or more members selected from the group consisting of: methyl (meth)acrylate, ethyl (meth)acrylate, propyl (meth)acrylate, butyl (meth)acrylate, amyl (meth)acrylate, hexyl (meth)acrylate, heptyl (meth)acrylate, octyl (meth) acrylate, 2-ethylhexyl (meth)acrylate, nonyl (meth)acrylate, decyl (meth)acrylate, undecyl (meth)acrylate, dodecyl (meth)acrylate, tridecyl (meth)acrylate, and stearyl (meth)acrylate.

6. The UV-curable semi-structural adhesive according to claim 1, wherein the second (meth)acrylate monomer comprises butyl acrylate.

7. The UV-curable semi-structural adhesive according to claim 1, wherein the free-radical polymerization photoinitiator is one or more members selected from the group consisting of: an acetobenzene initiator, an alpha ketone initiator, a benzoin ether initiator, an arylsulfonyl chloride initiator, and an oxime initiator.

8. The UV-curable semi-structural adhesive according to claim 1, wherein the (meth)acrylate composition further comprises an effective amount of a free-radical crosslinking agent, the free-radical crosslinking agent comprising an acryloxybenzophenone free-radical photocrosslinking agent.

9. The UV-curable semi-structural adhesive according to claim 1, wherein the (meth)acrylate composition further comprises an effective amount of a chain transfer agent, the chain transfer agent comprising a sulfur-containing chain transfer agent or a haloalkane chain transfer agent.

10. (canceled)

11. The UV-curable semi-structural adhesive according to claim 1, wherein the (meth)acrylate composition has a melting temperature of less than or equal to 40° C.

12. The UV-curable semi-structural adhesive according to claim 1, wherein the polymer base material is prepared by the steps of:
sealing the (meth)acrylate composition in a plastic package;
UV-radiating the (meth)acrylate composition in the plastic package to trigger polymerization; and
melt-extruding the UV-radiated (meth)acrylate composition with the plastic package to obtain the polymer base material.

13. The UV-curable semi-structural adhesive according to claim 12, wherein the intensity of the UV-radiation ranges from 0.01 to 20 mW/cm².

14. The UV-curable semi-structural adhesive according to claim 1, wherein the epoxy equivalent of the epoxy resin ranges from 150 to 600.

15. The UV-curable semi-structural adhesive according to claim 1, wherein the epoxy resin is an ester-ring epoxy resin.

16. The UV-curable semi-structural adhesive according to claim 5, wherein the ester-ring epoxy resin is obtained by reaction between polyphenol and epichlorohydrin.

17. The UV-curable semi-structural adhesive according to claim 16, wherein the polyphenol is one or more members selected from the group consisting of: bisphenol A, bisphenol F, bisphenol S, hexahydrobisphenol A, tetramethyl bisphenol A, diaryl bisphenol A, and tetramethyl bisphenol F.

18. The UV-curable semi-structural adhesive according to claim 1, wherein the photoacid generator is one or more members selected from the group consisting of diaryliodonium salts, triarylsulfonium salts, alkylsulfonium salts, iron aromatic hydrocarbon salts, sulfonyloxyketone, triaryl siloxane, hexafluoroantimonate, and triarylsulfonium hexafluorophosphate.

19. The UV-curable semi-structural adhesive according to claim 12, wherein the polymer base material further comprises a viscosity modifier that is an ethylene-vinyl-acrylate copolymer or an ethylene-acrylic acid copolymer.

20. (canceled)

21. The UV-curable semi-structural adhesive according to claim 20, wherein the plastic package comprises the ethylene-vinyl acrylate copolymer or the ethylene-acrylic acid copolymer.

22. A UV-curable semi-structural adhesive tape, the UV-curable semi-structural adhesive tape comprising:
an adhesive layer formed by the UV-curable semi-structural adhesive according to claim 1; and
a release layer attached to the adhesive layer.
